(19) United States
(12) Patent Application Publication
(10) Pub. No.: US 2020/0043115 A1
(43) Pub. Date: Feb. 6, 2020

(54) PERMISSIONED BLOCKCHAIN ECOSYSTEM FOR ECONOMIC DEVELOPMENT INCENTIVES

(71) Applicant: Zaius Networks Inc. doing business as (d.b.a.) BIGcontrols, Sausalito, CA (US)

(72) Inventors: Scott NELSON, San Francisco, CA (US); Karthik RAMASWAMY, San Jose, CA (US)

(21) Appl. No.: 16/053,077

(22) Filed: Aug. 2, 2018

(51) Int. Cl. G06Q 50/26; H04L 9/32; G06Q 30/00

(52) U.S. Cl. CPC G06Q 50/26; H04L 9/3268; H04L 2209/38; G06Q 30/018; H04L 9/3215

(57) ABSTRACT

Technologies for implementing a permissioned blockchain ecosystem for economic development incentives. In some examples, a method can involve establishing identities of entities interacting with a blockchain network, the entities including contributors, verifiers, and actors. The method can further involve receiving economic development incentive (EDI) data from a contributor for a permissioned blockchain of the blockchain network, and verifying the EDI data and a respective identity of the contributor. The method can involve, in response to verifying the EDI data and respective identity of the contributor, sending, to an orderer on the blockchain network, a signed transaction comprising the EDI data, and sending, to a blockchain wallet associated with the contributor, an EDI token issued for the contributor. The method can involve, based on the signed transaction, creating, by the orderer, transaction blocks including the EDI data and propagating the transaction blocks onto the permissioned blockchain.

### TECHNICAL FIELD

The present technology pertains to permissioned blockchain technologies.

### BACKGROUND

Economic development incentives (EDIs) are used by government jurisdictions to incentivize corporations to create new jobs and invest in their communities. The global EDI market has grown substantially from both the supply-side (e.g., governments) and demand-side (e.g., corporations). Such growth has resulted in increased regulatory standards from various bodies and government agencies seeking to steer performance-based investment behavior to increase their respective tax base with EDI as companies build new facilities and add jobs across the globe. Unfortunately, current solutions for EDI data provide a highly fragmented system of EDI data which is centralized among three large EDI data providers. Not only is the EDI data from these providers expensive, it is immeasurably lagging and largely incomplete, particularly when considering the frequency of law changes across the world.

The fragmented, unreliable, and often inaccurate nature of EDI data in current solutions is a significant obstacle for entities across the world wanting to access EDI data, conduct EDI transactions, and properly monitor or report EDI transactions and related information. Moreover, current solutions for EDI data and transactions lack adequate transparency, data compartmentalization, and identity validation procedures, and have limited data availability, scalability, and validation procedures.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A illustrates an example architecture for a decentralized ecosystem including a permissioned blockchain platform;

FIG. 1B illustrates an example blockchain configuration in accordance with various embodiments;

FIG. 2 illustrates an example logical design of a hyperledger blockchain network in the decentralized ecosystem shown in FIG. 1A;

FIG. 3 illustrates an example flow of a verifier executing a Proof-of-Authority procedure on a smart contract obligation between stakeholders and a contributor providing EDI data for the smart contract;

FIG. 4 illustrates an example method for implementing a decentralized ecosystem including a permissioned blockchain platform for economic development incentives; and

FIG. 5 illustrates an example computing device architecture in accordance with various embodiments.

### DETAILED DESCRIPTION

Various aspects of the disclosure are discussed in detail below. Features of one aspect may be applied to each aspect alone or in combination with other aspects. Moreover, while specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description.

As used herein, “one embodiment” or “an embodiment” can refer to the same embodiment or any embodiment(s). Moreover, reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Features described herein with reference to one embodiment can be combined with features described with reference to any embodiment.

The terms used in this specification generally have their ordinary meanings in the art, within the context of the disclosure and the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification, including examples of any terms discussed herein, is illustrative and not intended to limit the scope and meaning of the disclosure or any example term. Likewise, the disclosure is not limited to the specific embodiments or examples described in this disclosure.

Without an intent to limit the scope of the disclosure, examples of instruments, apparatus, methods and their related functionalities are provided below. Titles or subtitles may be used in the examples for convenience of a reader, and in no way should limit the scope of the disclosure. Unless otherwise defined, technical and scientific terms used herein have the meaning as commonly understood by one of ordinary skill in the art to which this disclosure pertains. In the case of a conflict, the present document and included definitions will control.

Additional features and advantages of the disclosure will be set forth in the description which follows, and in part will be recognized from the description, or can be learned by practice of the herein disclosed principles. The features and advantages of the disclosure can be realized and obtained by means of the instruments and combinations particularly pointed out herein. These and other features of the disclosure will become more fully apparent from the following description and appended claims, or can be learned by the practice of the principles set forth herein.

### Overview

Disclosed are systems, methods, and computer-readable media for implementing a permissioned blockchain ecosystem for economic development incentives. In some examples, a method can involve establishing, by a blockchain network, respective identities of entities interacting with the blockchain network. Each of the respective identities can be established based on a respective certificate issued by a certificate authority on the blockchain network for a respective entity. Moreover, the respective entities can include one or more contributors, one or more verifiers, and a plurality of actors. The plurality of actors can include, for example, government entities and private entities, such as companies, individuals, and organizations.

In some implementations, one or more actors, contributors, and/or verifiers can host peer nodes configured to interact with the blockchain network. For example, a private entity can host a peer node which interacts on the blockchain network via a decentralized RegTech application (RegTech dApp) configured to function as an oracle on the peer node, and a government entity can host a peer node which interacts on the blockchain network via a decentralized GovTech application (GovTech dApp) configured to function as an oracle on the peer node. An oracle can be a trusted agent that obtains, verifies and submits information to a blockchain for use by smart contracts deployed on the blockchain. Oracles can provide the necessary data to the ecosystem to trigger smart contracts to execute when the terms of the contract are met.

The method can further involve receiving economic development incentive (EDI) data submitted by a contributor for storage on a permissioned blockchain of the blockchain network. The EDI data can include legislation data associated with a respective government entity from the plurality of actors. The legislation data can include, for example, laws and/or regulatory statutes that govern economic development incentives created by the respective government entity. In some examples, the EDI data can also include other information about the EDI, such as how to apply for the EDI, what companies or industries can apply for the EDI, overall funding for the EDI program, etc.

After receiving the EDI data, the method can involve verifying, by a verifier on the blockchain network, the EDI data and a respective identity of the contributor. In some examples, the EDI data and/or the respective identity of the contributor can be verified based on an EDI smart contract associated with the blockchain network. Verifying the EDI data can include validating the quality and/or accuracy of the EDI data, checking for errors in the EDI data, verifying that the EDI data is not missing mandatory fields, formatting the EDI data according to a predetermined formatting scheme, deduplicating the EDI data, etc.

Moreover, the respective identity of the contributor can be verified based on a certificate issued by a certificate authority on the blockchain network for the verifier. In some cases, the verifier can be a third party or third party node that can verify the EDI data before the EDI data is stored on the permissioned blockchain of the blockchain network. The identity of the verifier can be verified to increase the reliability of the verification process. The identity of the verifier can be verified, for example, based on a certificate issued by the certificate authority for the verifier.

In some cases, the identity of the verifier can be used as stake. Verifiers can be required to disclose their identity and put their identity at stake to participate in the verification process. An actor's reputation can be tracked and/or made available on the blockchain network. Actors can harm or improve or build their reputation based on their actions. Thus, by staking their reputation, actors put their reputation at risk when they act in a malicious manner. Accordingly, actors having their reputation at stake are incentivized to uphold the verification process, maintain their integrity, and preserve the blockchain network.

Once the EDI data and the respective identity of the contributor have been verified, the method can involve sending, by the verifier to an orderer on the blockchain network, a signed transaction including the EDI data, and sending, to a blockchain wallet associated with the contributor, one or more EDI tokens issued for the contributor based on a token distribution smart contract. In some cases, the blockchain wallet is a wallet on a public blockchain, where the contributor can receive EDI tokens from the public blockchain as reward for contributing the EDI data. The EDI tokens can provide incentives for contributions to the blockchain network, and can be used to cover usage and/or subscription costs associated with the blockchain network. Thus, the contributor can later use the EDI tokens to cover fees for interacting with the blockchain network, including accessing EDI data on the blockchain network and/or conducting EDI transactions on the blockchain network.

In some cases, the EDI tokens can be sold in an exchange, where the EDI tokens may be traded for currency, services, property, financial instruments, contractual rights, digital currencies, etc. For example, a party can obtain EDI tokens for contributions made to the blockchain network and, if desired, sell any of the EDI tokens in a particular exchange or marketplace.

The method can also involve, based on the signed transaction creating, by the orderer, one or more transaction blocks including the EDI data and propagating the one or more transaction blocks onto the permissioned blockchain. In some cases, at some point prior to propagating the one or more transaction blocks onto the permissioned blockchain, the EDI data can be sent to a respective government entity associated with the EDI data for verification of the EDI data. The respective government entity can receive the EDI data and verify that the EDI data is valid.

The one or more transaction blocks can be propagated via a specific channel selected for propagating the one or more transaction blocks. The channel can be selected from a plurality of channels based on the EDI data, the country or jurisdiction associated with the EDI data, the government entity associated with the EDI data, etc. The channel can provide isolation of data between actors such as companies and governments. Memberships for the plurality of channels can be determined based on the respective identities established for the entities on the blockchain network. Each entity can have a common identity across all channels the entity is a member of.

In some implementations, the method can also involve storing, on the permissioned blockchain, a smart contract defining respective obligations for an EDI transaction between a government entity and a private entity from the plurality of actors. The EDI transaction can be based on EDI data on the permissioned blockchain, such as the EDI data submitted by the contributor to the blockchain network. A verifier can receive, from a peer node associated with the private entity, an indication that the private entity has completed the obligations defined in the smart contract for the private entity. The smart contract can be used to then verify that the private entity has fulfilled the obligations associated with the private entity.

Once the private entity's obligations have been verified, the smart contract associated with the EDI transaction will automatically execute to verify and/or commit the EDI transaction to the permissioned blockchain with finality. The smart contract can hash the EDI data to a block(s) on the permissioned blockchain, and push the EDI data to the private entity and the government entity. In other implementations, when the private entity's obligations have been verified, a notification can be sent to a peer node associated with the government entity, indicating that the private entity has fulfilled the obligations of the private entity. In response to receiving, from the peer node associated with the government entity, an acceptance of the verification of the respective obligations associated with the EDI transaction, the smart contract associated with the EDI transaction can be executed to verify and/or commit the EDI transaction to the permissioned blockchain with finality. The transaction block(s) associated with the EDI transaction can then be stored on the permissioned blockchain.

The transaction block(s) can include a record of the EDI transaction. The record can indicate that the respective obligations have been completed. The record will be available on the permissioned blockchain for parties to view the EDI transaction, track details regarding the EDI transaction, monitor compliance of the EDI transaction, generate audits associated with the EDI transaction, generate reports associated with the EDI transaction, capture statistics involving the EDI transaction, etc.

To reward or incentivize the verifier for verifying the EDI transaction and/or EDI data, an EDI token can be issued for the verifier. The EDI token can be issued for the verifier based on a token distribution smart contract, and sent to a blockchain wallet associated with the verifier. The blockchain wallet can be the verifier's wallet on a public blockchain, for example. The verifier can then use the EDI token to cover fees for interacting with the blockchain network, as previously explained.

### Description of Example Embodiments

The technologies herein provide a decentralized ecosystem for managing and implementing economic development incentives (EDIs). The decentralized ecosystem can provide EDI performance assurance, greater system efficiency and performance, as well as improved data security, reliability, and availability. The decentralized ecosystem can include a permissioned blockchain, EDI smart contracts, RegTech and GovTech dApps (decentralized applications) performing as oracles, a native EDI token for rewarding contributors and participants in the ecosystem, and a mechanism to receive and verify crowdsourced EDI data supplied by contributors to the ecosystem.

The EDI data can include laws and regulatory statutes that govern EDIs in various jurisdictions. In some examples, the EDI data can also include other information about the EDI, such as how to apply for the EDI, what companies or industries can apply for the EDI, overall funding for the EDI program, etc. The native EDI token can provide incentives for parties to grow the ecosystem and increase the reliability of the data and operations in the ecosystem. The permissioned blockchain and ecosystem can deliver added transparency, security, and assurance by providing identity and access management (IAM). To this end, the ecosystem can identify and verify actors in the ecosystem rather than anonymizing them as done by other blockchain technologies. The ecosystem can implement a process for identifying parties and verifying actions in the ecosystem.

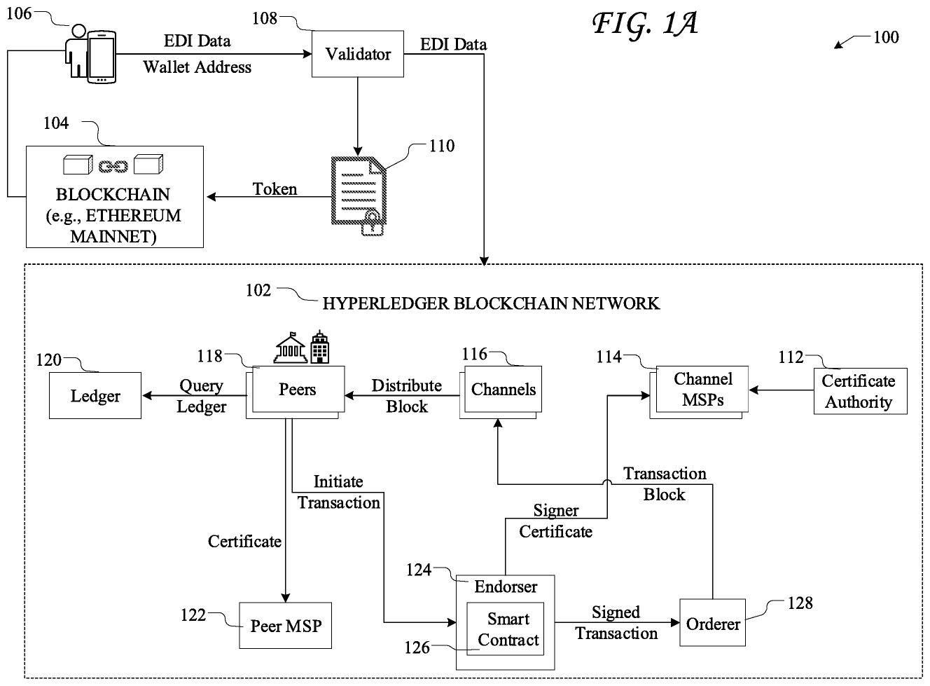

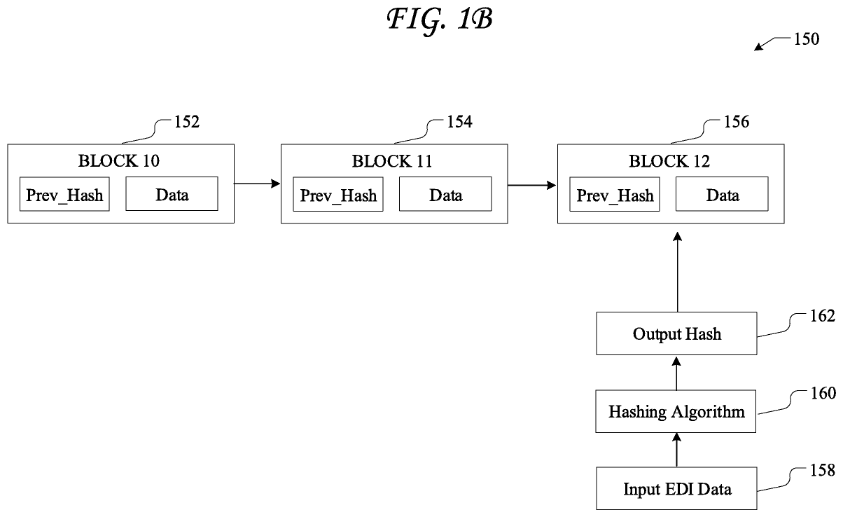

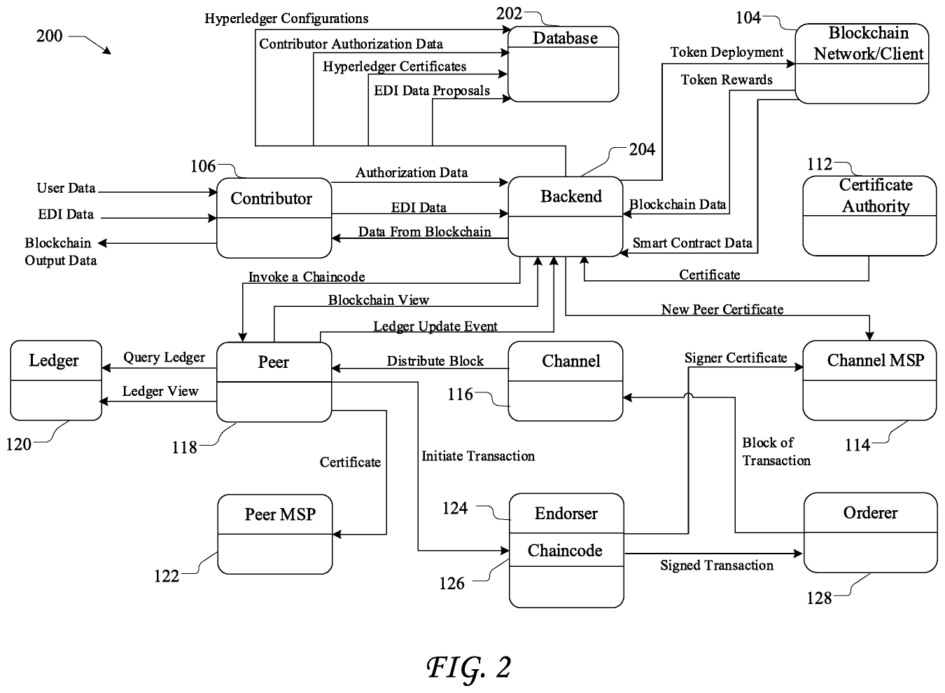

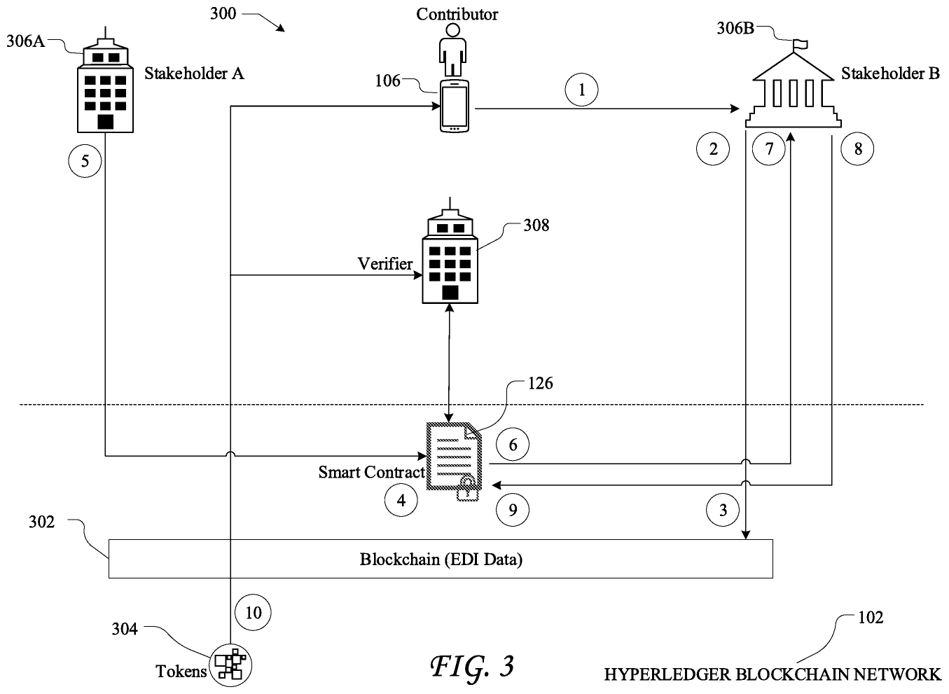

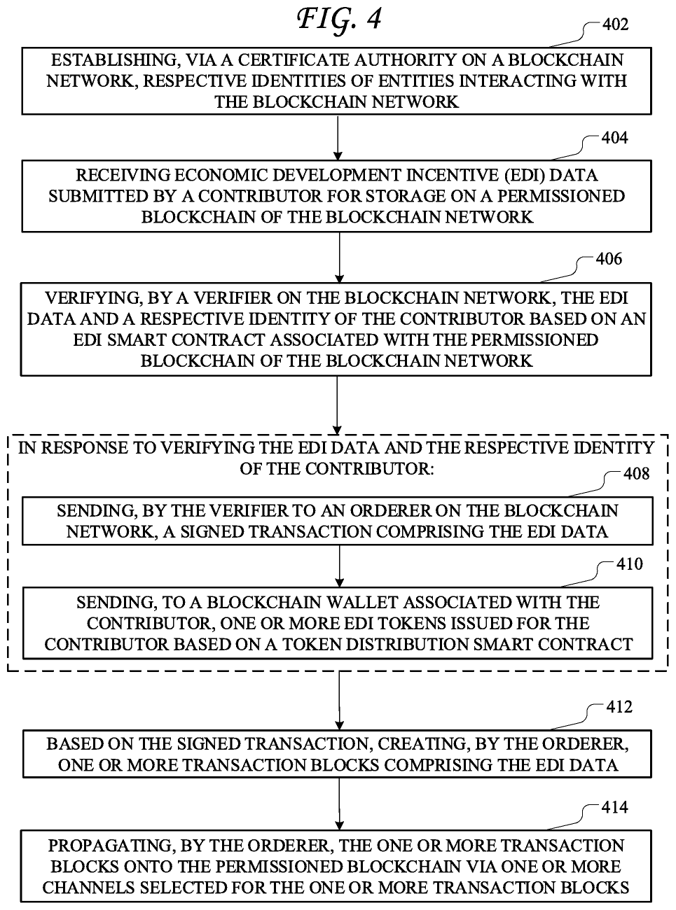

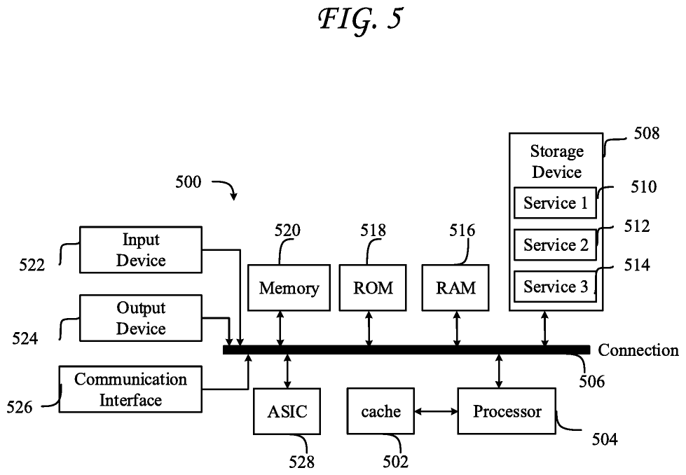

The present technologies will be further described in the disclosure as follows. The discussion begins with an overview of the decentralized ecosystem and related concepts. A description of an example architecture and logical system design, as illustrated in FIGS. 1A, 1B, and 2, and an example method and implementation, as illustrated in FIGS. 3-4, will then follow. The discussion concludes with a description of an example computing device, as illustrated in FIG. 5, suitable for interfacing with the decentralized ecosystem and performing computing operations. The disclosure now turns to an overview discussion of the decentralized ecosystem and related concepts.

The approaches herein provide an ecosystem for managing data and smart contracts in a decentralized manner, and implementing various security and assurance measures for data and operations in the ecosystem. The ecosystem can be utilized to manage various types of data and transactions. In some examples, the ecosystem can be utilized to manage economic development incentives (EDI), including related EDI data and transaction. In other examples, the ecosystem can be utilized to manage other types of data and transactions. For example, the ecosystem can be utilized to manage data and transactions in any regulated industry, such as banking, healthcare, etc. For the sake of clarity and explanation purposes, the ecosystem will be described herein in the EDI context.

Economic development incentives are used by government jurisdictions to incentivize corporations to create new jobs and invest in their communities. The global EDI market has grown substantially from both the supply-side (e.g., governments) and demand-side (e.g., corporations). Such growth has resulted in increased regulatory standards from various bodies and government agencies seeking to steer performance-based investment behavior to increase their respective tax base with EDI as companies build new facilities and add jobs across the globe. Underlying the entire market is a highly fragmented system of EDI data which is centralized among three large tax law data providers. Not only is EDI data from these providers expensive, it's immeasurably lagging and largely incomplete, particularly when considering the frequency of statutory law changes across the world.

### Regulatory Environment

The regulatory environment for EDI is multi-layered, with many regulators, government agencies, utilities, and other quasi-governmental standard-setting boards affecting it. Internationally, these entities are typically viewed on a country-by-country basis. However, there are certain bodies with multi-country authority such as the European Commission. In the U.S., these organizations reside at a Federal, state, or local level. With 206 sovereign states in the world today, there are tens of thousands of jurisdictions with oversight and regulating authority over corporations on various aspects of EDI.

When defining regulatory compliance for EDI, enforcement can be considered in two primary areas: 1) contractual obligations between corporations and governments when commitments are made for in-kind trade of value (e.g., jobs for tax breaks), and 2) industry standards specific to areas like accounting or taxation that apply to companies. The regulatory environment for both areas is constantly changing. Further, when multinational corporations operate in multiple countries, states and local jurisdictions, with EDI in each one, the complexity quickly becomes onerous.

### Financial Reporting Requirements

The activity around regulatory compliance and financial reporting in the industry depends on transparency. There is a great need for increased transparency in EDI for both governments and corporations. To this end, governments and corporations typically have financial statement disclosure requirement.

Regulators, governments and corporations alike are keenly aware of accounting and auditing requirements and the need for audits. Without accurate and reliable corporate disclosures and financial statements—and competent auditors to audit them the competitive free-market system may not function properly. The ecosystem herein can implement a permissioned blockchain to ease the burden and cost of such audits. The permissioned blockchain is a blockchain that requires permission to access the blockchain. The permissioned blockchain can have one or more owners. When adding records to the permissioned blockchain, the records can be checked and confirmed by one or more parties with access to the permissioned blockchain. The permissioned blockchain can provide verified data blocks with digital signatures that can be seen by those with permission.

By design, blockchains are inherently resistant to modification of stored data. Functionally, a blockchain can serve as an open, distributed ledger that can record transactions between two parties in a verifiable and permanent manner. The blockchain implemented in the ecosystem herein enables testing an entire population of transactions within a given period—a significant advance in the realm of audits.

In the blockchain, a transaction of relatively low value can take up to 10 minutes for validation as a single block verification is deemed appropriate. The further you go in the blockchain, the more the related transactions are immutable. Typically, a high value transaction can take approximately 1 hour to be verified. In today's world, information on financial transactions might take up to a month or more to be cleared. The near real-time verification enabled by the approaches herein can also have an indelible impact on the audit process. Instead of interim assessments or attestation at year end, audit firms and regulators can perform continuous online assessments throughout the period under audit.

### Fragmented and Low-Quality Data

The current market for EDI data is highly fragmented, disparate, and lacks standardization. In the U.S. alone, there are over 50,000 jurisdictions that provide EDI. Many of these jurisdictions maintain a list of their incentives and some may reference the regulatory statutes that give provenance to the data. However, most of that information is typically spread across multiple departments or government agencies in unlinked locations, as one agency is generally tasked with codifying the ordinance and another required to market the data.

There are currently no solutions which provide comprehensive EDI data, particularly when considering local jurisdictions and international geographies. When looking for EDI data, companies are forced into three courses of action: 1) navigate the highly fragmented systems available, 2) spend significant resources to purchase low quality data, or 3) hire expensive consultants who can marry (1) and (2) together along with their localized knowledge and bias toward specific jurisdictions. Whichever path a company chooses, the cost is high and the outcome less than ideal.

Blockchain technology can be implemented for storing data. However, existing blockchain protocols fall short of meeting many enterprise demands in areas such as performance, privacy, and governance. This is at least in part because blockchain protocols were designed to achieve consensus in a potentially nefarious environment, where anonymous participants can execute transactions. In order to deter this type of hostile behavior, transactions submitted to each block are transparent where every node has visibility across the network and Byzantine fault tolerant consensus algorithms become the standard. While public blockchains require these types of guardrails to ensure proper network behavior, enterprise requirements are largely sacrificed as a result.

In addition, public blockchain networks are very inefficient and require significant power consumption and resources. For example, the annual energy consumption of the Bitcoin network is equal to 59.87 terawatt-hours (TWh), with current annualized estimated mining costs of nearly $3 billion. For context, the Bitcoin network would be ranked the 43rd largest consumer of energy among countries throughout the world.

### A Stakeholder-First Approach

Adapting blockchain technologies to the needs of enterprises and governments within a broader ecosystem begins with re-examining the environment in which the blockchain operates. In a public blockchain network, anyone can transact on the network, actors on the network are untrusted, and anyone can add nodes to the network. All actors have full access to the blockchain with the ability to participate in the established consensus protocol.

In contrast, with the permissioned blockchain herein, stakeholder identities and nodes are known and controlled. Actors are mature with robust and highly controlled computing environments, security policies, and other characteristics of the enterprise and government agencies.

Moreover, smart contracts, or “autonomous agents”, can be implemented to allow actual contracts or agreements to be converted to computer code, stored and replicated on a system supervised by the network of nodes that run the blockchain. Smart contracts are contracts that are written in computer code and operate on a blockchain or distributed ledger. The smart contracts can not only define the rules and penalties for an agreement or transaction, but can also enforce them. The smart contracts can automatically verify, execute and enforce the contract based on the terms or rules written in the code. Smart contracts can be partially or fully self-executing and self-enforcing.

The permissioned blockchain and smart contract technologies can be leveraged herein to create an ecosystem available to all stakeholders, which meets the performance, security, and data requirements of the stakeholders. Cryptography and compliance mechanisms can be implemented in an ecosystem that is digitally secured and stored across an immutable distributed ledger with built-in audit trails. The disclosed approaches to crowdsourcing and democratizing EDI data can also disintermediate the process of data distribution and establishment of data provenance.

The disclosed technologies can implement a decentralized ecosystem for economic development incentives. The ecosystem can include a permissioned blockchain, EDI smart contracts, RegTech and GovTech dApps (decentralized applications) as oracles, a native EDI token, and an application that allows contributors to supply crowdsourced EDI data to the ecosystem. Decentralized applications (dApps) are applications that run across a distributed blockchain or network of computers. Decentralized applications do not have a central server. Computers running decentralized applications can connect to each other through peer-to-peer connections.

The ecosystem is designed to eliminate the regulatory compliance friction that exists amongst the Stakeholders, increase the financial reporting transparency required by industry standards, democratize global EDI data, etc. Stakeholders can include entities that provide EDI (e.g., governments, utilities, etc.) and entities or parties that receive EDI (e.g., companies). The ecosystem can also incentivize verifiers who can verify that stakeholders have met their obligations pursuant to the smart contracts on the blockchain. Verifiers can include entities (e.g., payroll companies, banks, utility companies, among others) that can provide said verifications around smart contract obligations, such as job creation, investment, and other contractual EDI commitments.

In order to operate in the ecosystem, stakeholders can subscribe to an oracle product, such as a RegTech dApp for companies or GovTech dApp for government agencies. These products provide additional off-chain value as described above. The two products can serve as oracles and interoperate with the blockchain and its smart contracts. Oracles can serve as trusted agents that obtain and verify information and submit the information to a blockchain for use by smart contracts deployed on the blockchain. The oracles can provide the necessary data to the ecosystem to trigger smart contracts to execute when the terms of the contract are met.

When companies enter into EDI agreements with government agencies, their contractual obligations can be digitized into smart contracts on the blockchain. A verifier for that particular smart contract can receive data originating from the stakeholder based on the smart contract code. Once the verifier validates the smart contract conditions, data can be sent to the corresponding government agency stakeholder. The government stakeholder's dApp can then be updated, and the smart contract executed. The data can be “hashed” on the blockchain to create an immutable audit trail.

Contributors can provide crowdsourced EDI data to the ecosystem based on a standardized data schema manifest. Contributors can include economists, professional economic development practitioners, government agency officials, attorneys, accountants, professors, law students, etc. The standardization of data sets can ensure that the stakeholders in the ecosystem enjoy the same quality of data across the world in every jurisdiction.

The ecosystem design can be structured to provide maximum security while operating as efficiently as possible. In some cases, the ecosystem can leverage multiple blockchain networks, such as a public blockchain network and a separate hyperledger fabric, in a hybrid infrastructure for permissioned blockchains and smart contracts. Some example benefits of the ecosystem herein can include Proof-of-Authority (PoA) consensus protocol, privacy and control features, on-premises data, ERC20 token standard, etc.

### Actors, Identity, and Proof-of-Authority Consensus

There are three types of actors in the ecosystem. First, stakeholders which can include corporate or government participants that can transact on the blockchain. Stakeholders can run authority nodes (AN) and can transact on the network. Multiple accounts can act on the same node.

Second, verifiers which can include corporate participants whose responsibility is to both validate identification of stakeholders and verify that stakeholders have met their obligations pursuant to the smart contracts on the blockchain. Verifiers can also be government agencies or individuals who validate EDI data submitted to the ecosystem. The governance around verifiers can be implemented on a smart contract level.

Finally, contributors which include individual participants whose primary responsibility is to provide crowdsourced EDI data to the ecosystem based on a standardized data schema manifest, including updated data on an ongoing basis.

The permissioned blockchain can provide identity and access management (IAM) functionality. As such, the ecosystem can identify rather than anonymize actors in the ecosystem. The identification process can involve 1) identifying an actor's identity (e.g., someone asserts that Actor A is Actor A), and 2) third-party identity verification where a third-party verifies the actor's identity. The third-party can be an external third-party who can examine Actor A's identifying information, such as a FEIN, corporate tax ID, or passport, and verify Actor A's identifying information. Actors can be identified as corporations or individuals, for example. Another component of the verification process can involve associating Actor A with actions taken in the ecosystem.

In addition, a Proof-of-Authority (PoA) consensus protocol can be deployed in the ecosystem, where approved actors, which will be referred to as “verifiers” herein, validate transactions and blocks. These verifiers can be implemented on a smart contract level. In some cases, verifiers can be prevented from issuing or adding blocks to the blockchain. There is an economic incentive for verifiers to maintain their reputation in the ecosystem. Verifiers are therefore incentivized to uphold the integrity of the transaction process.

### Token Model Design

Tokens can be implemented as a medium of exchange. This can reduce or eliminate the issues around the double coincidence of wants. When actors in the ecosystem provide or verify EDI data, they are compensated for doing so with an EDI token. Government agencies can similarly be incentivized with EDI tokens. Government agencies can receive a defined amount of EDI tokens for every corporation they refer into the ecosystem. In turn, these agencies can use their EDI tokens to reduce or eliminate the cost of their GovTech dApp. This allows the token model to drive behaviors that support the network effects for the ecosystem. This multi-faceted token model, where the various actors are incentivized, can increase stability and lead to widespread adoption.

The ecosystem operates without a centralized authority to oversee and govern the actors in the ecosystem. This token model can drive the correct behavior of actors in alignment with the goals of the community and stakeholders. For example, as a stakeholder corporation puts more EDI agreements on-chain, they can receive an allocation of tokens as a reward for being increasingly more transparent. Those corporations can then use their EDI tokens to reduce the cost of their RegTech dApp.

The EDI token can be distributed to verifiers as a reward for verifying the obligations in smart contracts or positively verifying EDI data submitted by a contributor. Likewise, EDI tokens can be issued to contributors for providing EDI data to the ecosystem once it's properly validated. The amount of EDI tokens distributed can be defined by a smart contract and/or the complexity of EDI data submitted to the ecosystem according to its governance rules.

In addition to using EDI tokens as a medium of exchange and store of value, the tokens can be used as an economic incentive for actors to grow and maintain the ecosystem. Actors can be charged a token fee for transacting within the ecosystem as a way to create a free market flow of tokens back to the community. The tokens can be deposited to a specific reserve account for future allocation to the ecosystem. This circular method of free flow tokens back to the community creates a mechanism for supply that helps maintain the long-term viability of the ecosystem. The EDI tokens can enable the actors to share in the value generated by the network and inspire new actors to join.

The token model can require actors to hold a minimum amount of EDI tokens in order to interact with the ecosystem. To enforce penalties against bad actors, they can be required to keep a minimum defined amount of EDI tokens which acts as a stake to safeguard them against potential claims. This protocol can provide confidence in the system and each transaction.

EDI token holders can use their EDI tokens to buy EDI data and pay for existing products. By using a token specific to the ecosystem, the EDI token can deliver certain advantages, such as: allowing for automatic reconciliations on smart contract obligations with immutable audit trails; incentivizing the community of actors and aligning their goals, which provides a mechanism for network effects; issuing a standardized method of value across numerous jurisdictions for businesses, governments, and/or individuals in the ecosystem; facilitating the creation of incentives for growth and network effects for the ecosystem through a uniform medium of exchange and a harmonized store of value; providing greater price stability over time as adoption increases; etc.

In some cases, the EDI tokens can be traded or sold in an exchange or marketplace. The EDI tokens may be traded in the exchange or marketplace for currency, services, property, financial instruments, contractual rights, digital currencies, etc. For example, a party can obtain EDI tokens for contributions made to the blockchain network and, if desired, sell any of the EDI tokens in a particular exchange or marketplace. The ability to exchange EDI tokens for other forms of value can provided added flexibility and incentive for parties in the ecosystem and increase participation in the ecosystem.

### Framework for Governance

The ecosystem can describe and manage governance policies. These policies can include the stakeholder list, AN (authority node) list, code charter, data governance policies, etc.

The stakeholder list is a list of approved actors (stakeholders and contributors) in the ecosystem according to the PoA protocol policy. A stakeholder, S1, can be represented by its private/public key pair {PrivKeyS1, PubKeyS1}. If S1 to S1 are stakeholders in the ecosystem, the stakeholder list can be represented by the public key set {PubKeyS1, . . . , PubKeyS1}. In some cases, only each stakeholder's public key certificate is uploaded into the ecosystem. Each stakeholder's private key can remain in the IAM system. Contributors can maintain their own private keys.

The code charter is the specification of approved code that can run within the ecosystem, including but not limited to oracles, blockchain protocols, and specific blockchain protocol versions.

The AN list is a list of approved validating nodes in the network. An AN is represented in the ecosystem by a signed tuple that can include the stakeholder's identity, the address (e.g., DNS name or IP address) of the physical node, and the public key corresponding to the private key generated within the enclave to uniquely identify the AN/secure enclave pair.

Data governance policies can focus on collecting, creating, defining, aligning, prioritizing, monitoring and enforcing many types of data-related rules. While these policies can act as core policies for the ecosystem, additional policies can also be implemented and are contemplated herein.

### Regulatory Compliance

Leveraging crowdsourced EDI data, the EDI token, and the marriage of RegTech and GovTech, the ecosystem provides a permissioned blockchain platform connecting corporations and government agencies for regulatory compliance and financial reporting disclosures required for the EDI contract obligations between the two. Further, the ecosystem design incentivizes the stakeholders, verifiers, and contributors as a means to providing both provenance and finality.

Having disclosed example elements of a decentralized ecosystem and related concepts, the disclosure now turns to FIG. 1A which illustrates an example architecture for a decentralized ecosystem 100 including a permissioned blockchain platform. The decentralized ecosystem 100 can be implemented to manage EDIs, EDI data, and EDI transactions, as previously described.

In this example, the decentralized ecosystem 100 includes Hyperledger blockchain network 102 and public blockchain 104. Hyperledger blockchain network 102 can represent a blockchain-based distributed ledger or platform such as, without limitation, Hyperledger Fabric and the like. Public blockchain 104 can represent a public blockchain network such as Ethereum Mainnet, for example. A contributor 106 can provide EDI data for inclusion in the Hyperledger blockchain network 102. The EDI data can include data about laws and regulations that govern EDI, data pertaining to EDI transactions, metadata, etc. The contributor 106 can also provide a wallet address which can be used to receive tokens issued by the public blockchain 104 as a reward for the EDI data. The tokens can be issued via smart contract 110 on the public blockchain 104.

Smart contract 110 can be a contract written in computer code with terms or rules for issuing and/or distributing EDI tokens to parties for specific contributions to the ecosystem 100, such as contributions of EDI data, verification or validation of EDI data and/or transactions, etc. The smart contract 110 can verify, execute and/or enforce an EDI token distribution contract based on the terms written in the computer code.

The EDI data from contributor 106 can be received by a validator service 108 that validates the EDI data and the contributor 106 before it is propagated to the Hyperledger blockchain network 102. In validating the EDI data, the validator service 108 can verify the quality and validity of the EDI data. In some cases, the validator service 108 can check and verify that the EDI data is not duplicative or contains errors.

The validator service 108 can also perform a know your customer (KYC) process and add reputation validation information to the Hyperledger blockchain network 102. The validator service 108 can validate the reputation of the contributor 106 based on the actions of the contributor 106 (e.g., the contribution of the EDI data). The reputation validation information can include an indication of the reputation of the contributor 106 as determined by the validator service 108 based on the actions of the contributor 106. For example, the reputation validation information can include a reputation score, rating, assessment, history, profile, record, and/or any other information pertaining to the reputation of the contributor 106 and/or any of the transactions/actions conducted by the contributor 106. The reputation information and any transaction information associated with the contributor 106 can be registered on the Hyperledger blockchain network 102 for tracking and access to the established reputation (or lack thereof) of the contributor 106. As previously mentioned, the reputation of an actor can change through time based on the actions of the actor.

Once the validator service 108 is able to verify the EDI data and contributor 106, an EDI token can be issued through the public blockchain 104 to the contributor 106 as a reward for contributing the EDI data, and the validated EDI data can be submitted to the Hyperledger blockchain network 102 for processing and use by actors in the Hyperledger blockchain network 102. Actors can include contributor 106 as well as stakeholders, such as companies and government agencies. Such stakeholders can run peer nodes 118 to access and publish data in the Hyperledger blockchain network 102. However, in some cases, stakeholders are not required to run peer nodes 118 in the Hyperledger blockchain network 102. For example, a stakeholder may not have the resources, expertise or desire to run a peer node and thus may opt out of doing so.

Endorser 124 can validate the EDI data via smart contract 126. The smart contract 126 can also be used to format the EDI data according to a formatting scheme implemented on the Hyperledger blockchain network 102 and perform data deduplication to ensure that duplicate data is not added to the ledger 120 in the Hyperledger blockchain network 102.

The smart contract 126 can be a contract written in computer code with terms or rules for verifying/validating EDI data and/or transactions, formatting EDI data, deduplicating EDI data, enforcing EDI contracts, etc. The smart contract 126 can verify, execute and/or enforce an EDI contract based on the terms written in the computer code.

In some examples, the endorser 124 uses digital certificates to verify the identity of the contributor 106. For example, the endorser 124 can use digital certificates issued by a certificate authority (CA) 112 in the Hyperledger blockchain network 102 to associate the contributor 106 with a specific identity. The verification process can implement one or more cryptographic schemes, such as a public key infrastructure (PKI) scheme. Any actor (e.g., contributor 106, stakeholders, etc.) that seeks EDI data can be enrolled into the Hyperledger blockchain network 102 using one or more cryptographic techniques.

The CA 112 can serve as the authority of identities of actors in the ecosystem 100, and enable a Proof-of-Authority (PoA) consensus protocol in the Hyperledger blockchain network 102. In some cases, all certificates, including certificates for channel membership service providers (MSPs) 114, peers 118, peer MSPs 122, contributor 106, endorser 124, etc., can be issued by the CA 112 and used for identity verification. If an actor, such as a government or corporation, wishes to participate in multiple channels 116, the CA 112 can help ensure that such actor has the same established identity across the channels 116. This ensures that an actor has a common/shared identity across the channels 116 in the Hyperledger blockchain network 102. The actor can thus be mapped to the same identity for all transactions by the actor in the Hyperledger blockchain network 102.

For example, before EDI data for a government entity is added into the Hyperledger blockchain network 102, the CA 112 can establish an identity for the government entity. The identity can be established by generating public and private key information using one or more cryptographic techniques. Once the identity is established for the government entity, the government entity can receive all information about the EDI data submitted by the contributor 106 pertaining to the government entity's jurisdiction.

Once the endorser 124 has verified the EDI data submitted by the contributor 106, it can submit a signed transaction to the orderer 128. The endorser 124 can also send the signer's certificate to the channel MSPs 114, which can authorize use of one or more channels 116 based on an identity verified through the signer's certificate. Channel MSPs 114 can control authentication authorizations for which actors can be part of a channel. The channels 116 can provide isolation of EDI data and/or transactions for actors in the Hyperledger blockchain network 102. The channels 116 can be established based on, for example, a respective country, jurisdiction, agency, actor, etc.

The orderer 128 receives the signed transaction from the endorser 124 and submits the transaction to one or more respective channels 116 as transaction blocks. The orderer 128 can thus distribute the transaction blocks to respective peers 118 through respective channels 116. In some cases, before distributing the transaction blocks, the orderer 128 can establish consensus on the order of transactions.

The transaction blocks are recorded on the ledger 120 for access in the Hyperledger blockchain network 102. In some instances, if the transaction blocks contain EDI data, the transaction blocks containing the EDI data can be recorded on the ledger 120 for access by actors interested in the EDI data, such as private entities interested in an associated EDI or a government entity associated with the EDI. In other cases, the transaction blocks contain data about an EDI transaction between two or more parties (e.g., an EDI agreement and any associated information between a private party and a government entity). However, it should be noted that in other implementations, transaction blocks containing EDI data and/or data about an EDI transaction between parties can be made accessible to any actors in the Hyperledger blockchain network 102 or restricted to specific actors in the Hyperledger blockchain network 102 based on security or privacy policies and/or preferences, for example.

The EDI data can be stored on the ledger 120 in a standard format (e.g., as formatted via the smart contract 126) for ease of interoperability. The ledger 120 can be distributed across different peers 118, countries, organizations, etc. Records on the ledger 120 can be stored in a continuous manner. The ledger 120 can be permissioned, thus requiring permission to access data on the ledger 120. The permissioned ledger 120 can provide verified data blocks with digital signatures that can be seen by those with permission.

The peers 118 can store a copy of the ledger 120 which they can use to access data on the ledger 120. The peers 118 can query the ledger 120 to access EDI data and EDI transactions as desired. For example, the peers 118 can access the EDI data in the ledger 120 to perform audits, generate reporting disclosures, monitor transactions, track progress on EDI obligations, etc.

The peers 118 can use EDI data in the ledger 120 and/or EDI data submitted to the Hyperledger blockchain network 102 to initiate transactions with other peers. In some cases, when initiating a transaction, the peers 118 can send their respective certificates to peer MSP 122, which can use the certificates to associate the peers 118 with a respective identity and validate the respective identity of the peers 118. The peers 118 can then communicate with the endorser 124 to initiate a transaction. The endorser 124 can validate the transaction and send the signed transaction to the orderer 128. The orderer 128 can then distribute the transaction blocks through the channels 116, as previously explained. All transactions submitted can be queried from the ledger 120 in the respective channels 116.

FIG. 1B illustrates an example blockchain configuration 150 according to various aspects of the present disclosure. An example blockchain (e.g., ledger 120) can include blocks 152, 154, 156 used to store data, such as EDI data and transactions submitted to the blockchain network 102. The blocks 152, 154, 156 are records on the blockchain that contain data (e.g., EDI data and/or information about EDI transactions) and information to verify the blocks 152, 154, 156 are valid parts of the blockchain.

Block 10 (152) shows example block components. As illustrated, block 10 (152) can include data and information about the previous hash. EDI data and/or data about an EDI transaction can be stored in the data portion of the block 10 (152). The block 10 (152) can include any EDI data and/or transaction information in a predetermined format. The format can be based on a formatting scheme defined by the blockchain network 102.

The data portion can also include metadata associated with the EDI data and/or EDI transaction, such as, for example, a timestamp, a nonce, a signature, verification data, PoA data, block header information, and/or any other metadata. The nonce can be a random or pseudorandom number issued to ensure that old communications cannot be reused, for example, to carry out replay attacks. In some cases, the nonce can be applied to a message before hashing it in order to prevent a party that reuses the message format/contents having their hashes brute-forced by a third-party with access to the blockchain data.

Block 11 (154) and block 12 (156) show a similar structure with a respective portion of information about the previous hash and a respective data portion which can include EDI data, information about respective EDI transactions, signatures, verification data, PoA data, block header information, metadata, etc. The different portions of the blocks 152, 154, 156 can be hashed based on a hashing algorithm (e.g., 160).

Each of the blocks 152, 154, 156 can permanently record the transactions and data it contains onto the blockchain. Each block contains information about the previous block, creating a chain of blocks as previously explained.

In one example, input EDI data 158 submitted to the blockchain network 102 can be hashed by a hashing algorithm 160, which generates an output hash 162. Hashing algorithm 160 can be any hashing algorithm for securely hashing input data to be stored on the blockchain. In some cases, the output hash 162 can be signed by an endorser (e.g., 124) on the blockchain network 102. The signed and hashed EDI data is then deployed on the blockchain.

In one example, input EDI data 158 can include EDI data for an entire EDI transaction. This can include the actual record of the EDI transaction as well as any related transaction metadata. In another example, input EDI data 158 may not include the EDI data for an entire EDI transaction but rather all transaction metadata (e.g., all communications and records pertaining to an EDI transaction but not the final transaction). This record once submitted to the blockchain network 102 and embedded in the blockchain can be used to audit EDI transactions, report EDI transactions and/or compliance, track EDI transactions and/or related data, access EDI data, conduct future EDI transactions, etc.

FIG. 2 illustrates an example logical design 200 of the Hyperledger blockchain network 102. In this example, database 202 can store hyperledger configurations, offchain contributor (106) authorization data, hyperledger certificates, and offchain EDI data proposals. The database 202 can receive the hyperledger configurations, offchain contributor authorization data, hyperledger certificates, and offchain EDI data proposals from the backend 204.

The backend 204 can transmit token deployment information to the public blockchain 104 for storage. The token deployment information can be used to determine when and how to manage and/or deploy tokens in the ecosystem 100 as incentives for data contributions and verifications. The public blockchain 104 can send to the backend 204 token rewards information, blockchain data, and smart contract data such as account information, account balance of tokens, etc. The token rewards information, blockchain data, and smart contract data can be used to manage and implement the token system in the ecosystem 100.

The backend 204 can receive certificates from the CA 112. The backend 204 can send new peer certificates to channel MSP 114. The backend 204 can also send data from the blockchain (e.g., ledger 120) to the contributor 106 (e.g., to the contributor frontend). The contributor 106 can then output the blockchain data as requested.

The contributor 106 can receive user and EDI data for the ecosystem 100. The contributor 106 can then send authorization data and the provided EDI data to the backend 204.

The backend 204 can communicate with peer 118 to invoke a chaincode (e.g., smart contract 126). The peer 118 can send the respective peer certificate to peer MSP 122 for identity verification, and communicate with endorser 124 to initiate a transaction. The endorser 124 can invoke the chaincode 126 (e.g., smart contract) to format, validate, and/or deduplicate associated EDI data or transaction. The endorser 124 can send a signer certificate to channel MSP 114 for verification and the signed transaction to the orderer 128. The orderer 128 can create a block of transaction and send the block for distribution to the peer 118 through the channel 116.

The peer 118 can query and view the ledger 120 to access EDI data and related information. The peer 118 can also provide a blockchain view and ledger update events to the backend 204.

FIG. 3 illustrates an example flow of a verifier executing a PoA on a smart contract obligation between stakeholder 306A (e.g., corporation A) and stakeholder 306B (e.g., government agency B), and a contributor 106 providing EDI data for the smart contract 126.

The contributor 106 first submits EDI data to the ecosystem (e.g., 100) on a specific EDI. If the EDI data is specific to stakeholder 306B, the EDI data can be routed to the stakeholder 306B for verification of the EDI data by the stakeholder 306B. However, in some examples, the contributor 106 can submit the EDI data to the blockchain 302 (e.g., ledger 120) on the Hyperledger blockchain network 102 without first having the EDI data verified by an associated stakeholder (e.g., 306B). For illustration purposes, in this example, the EDI data pertains to stakeholder 306B and is routed to stakeholder 306B for verification. Once the EDI data is verified by stakeholder 306B, it is propagated to the blockchain 302.

The EDI data is also propagated to the GovTech dApp of stakeholder 306B and the RegTech dApp of stakeholder 306A. The EDI data can also be pushed to every other RegTech dApp on the Hyperledger blockchain network 102.

Assume that stakeholder 306A utilizes the EDI data and commits to creating 100 jobs over each of the next 10 years. In return, stakeholder 306B will give stakeholder 306A a property tax abatement for each of those 10 years as long as stakeholder 306A fulfills its obligation of creating 100 jobs each year and reports the compliance data back to stakeholder 306B. If stakeholder 306A does not fulfill its commitments, it must pay back all of the tax relief it has received and forgo any future benefit. The obligations between stakeholder 306A and stakeholder 306B are digitized into the smart contract 126 and put on the blockchain 302.

At the end of the first year, stakeholder 306A executes its compliance in its RegTech dApp. The trigger is sent to the blockchain 302 for verifier 308 to verify the smart contract obligations of stakeholder 306A.

Assume the verifier 308 in this example is a payroll company that can verify the obligations of stakeholder 306A through the PoA consensus protocol of the ecosystem (100). Once the verifier 308 positively verifies the obligation of stakeholder 306A, the smart contract 126 executes, and the transaction block with the compliance data is hashed, stored on the blockchain 302 and sent to Stakeholder 306A and Stakeholder 306B.

In other implementations, when the verifier 308 positively verifies the obligation of stakeholder 306A, the smart contract 126 can execute and the compliance data can be sent to the GovTech dApp of stakeholder 306B. In this example, stakeholder 306B is notified and the GovTech dApp of stakeholder 306B is automatically updated with information indicating that stakeholder 306A is compliant with its obligations based on the smart contract 126 and the PoA consensus verification of the verifier 308. Moreover, stakeholder 306B can initiate acceptance of the PoA consensus verification in their GovTech dApp. A trigger can then be sent to the blockchain 302 for smart contract execution. Once the smart contract 126 receives the PoA consensus verification from the GovTech dApp of stakeholder 306B, the smart contract 126 can executes and the transaction block can be hashed and stored on the blockchain 302.

EDI tokens 304 can be distributed to the contributor 106 for submitting the EDI data and the verifier 308 for validating the transaction based on the allocation code of the smart contract 126.

In some cases, the smart contract 126 can include alternative conditions or obligations for a contract, which the smart contract 126 can dynamically execute and enforce. For example, the smart contract 126 can define an agreement between stakeholder 306A and stakeholder 306B where both agree that stakeholder 306A will create 10 jobs each year for 2 years in exchange for a specific tax reduction from stakeholder 306B. In addition, the smart contract 126 can include terms or rules for handling different scenarios of partial compliance by one or more of the parties.

To illustrate, if stakeholder 306A creates 12 jobs on year one and 8 jobs on year two, when determining/enforcing compliance of stakeholder 306A on year two, the smart contract 126 can add the extra 2 jobs created by stakeholder 306A on year one to the 8 jobs created by stakeholder 306A on year two and accordingly confirm that stakeholder 306A has met its obligation of creating 10 jobs on year two. In other words, the smart contract 126 can include terms that allow for over performance in previous years to be included in, or carried over to, an underperforming year(s).

As another example, the smart contract 126 can include alternative terms which allow one parties' obligations to be adjusted when the other party exceeds or fails to meet all of its obligations. In other words, the smart contract 126 can modify or eliminate one or more obligations set for one party based on under or over performance by another party. To illustrate, the smart contract 126 can include a first set of terms defining an agreement requiring stakeholder 306A to create 10 jobs in exchange for a specific tax reduction from stakeholder 306B, and a second set of terms for reducing the tax reduction amount promised by stakeholder 306B by a certain amount or percentage if stakeholder 306A creates a certain amount of jobs above or below the 10 jobs that stakeholder 306A agreed to create.

For example, the first set of terms can provide that stakeholder 306A will get x amount of tax reductions from stakeholder 306B in exchange for creating 10 jobs, and the second set of terms can provide that stakeholder 306A will instead get x-y amount of tax reductions if stakeholder 306A creates 10-n jobs (e.g., 8 jobs). In this example, if stakeholder 306 does create the 10 jobs, the smart contract 126 can enforce the first set of terms and validate the respective obligations of stakeholder 306A and stakeholder 306B under the first set of terms, and if stakeholder 306 instead creates 10-n jobs, the smart contract 126 can enforce the second set of terms and validate the respective obligations of stakeholder 306A and stakeholder 306B under the second set of terms. In this way, the smart contract 126 can define different paths for compliance and dynamically apply the rules for the various paths.

Having disclosed various system components and concepts, the disclosure now turns to the example method for implementing a permissioned blockchain ecosystem for economic development incentives, as shown in FIG. 4. For the sake of clarity, the method is described in terms of ecosystem 100, as shown in FIG. 1A. The steps outlined herein are non-limiting examples provided for illustration purposes, and can be implemented in any combination thereof, including combinations that exclude, add, or modify certain steps.

At step 402, the method can involve establishing, via a certificate authority (112) on a blockchain network (102), respective identities of entities interacting with the blockchain network (102). The entities can include one or more contributors (e.g., 106), one or more verifiers (e.g., 108, 124), and a plurality of actors (e.g., 118). The plurality of actors can include one or more private entities, such as companies, and one or more government entities. The respective identities can be verified using respective certificates issued by the certificate authority (112). The entities can obtain public and private cryptographic keys to validate their identities and secure their interactions with the ecosystem (100).

At step 404, the method can involve receiving economic development incentive (EDI) data submitted by a contributor (e.g., 106) for storage on a permissioned blockchain (e.g., 120) of the blockchain network (102). The EDI data can include legislation data associated with a respective government entity from the plurality of actors. When submitting the EDI data, the contributor can also provide a wallet address where the contributor can receive EDI tokens as reward for contributing EDI data to the blockchain network (102).

At step 406, the method can involve verifying, by a verifier (e.g., 108 and/or 124) on the blockchain network (102), the EDI data and a respective identity of the contributor (e.g., 106) based on an EDI smart contract (126) associated with the permissioned blockchain (e.g., 120) of the blockchain network (102). The verifier can verify the contributor's identity based on, for example, a certificate issued for the contributor by the certificate authority (112). Moreover, when verifying the EDI data, the verifier can validate the accuracy of the EDI data, check for errors in the EDI data, check that all mandatory fields in the EDI data have data, verify that the EDI data is not duplicative, ensure the EDI data is properly formatted, etc. In some cases, the EDI data can be formatted according to a predetermined formatting scheme before it is published on the blockchain network (102).

In response to verifying the EDI data and the respective identity of the contributor, at step 408 the method can involve sending, by the verifier to an orderer (e.g., 128) on the blockchain network (102), a signed transaction including the EDI data, and at step 410 sending, to a blockchain wallet associated with the contributor (e.g., 106), one or more EDI tokens issued for the contributor based on a token distribution smart contract (e.g., 110). In some cases, the blockchain wallet can be a wallet on a public blockchain (e.g., 104), such as Ethereum Mainnet.

As part of verifying the EDI data and sending the signed transaction to the orderer, the verifier can verify its own identity with one or more entities in the blockchain network (102). For example, the verifier can send a respective certificate issued by the certificate authority (112) for the verifier to one or more channel MSPs (e.g., 114) which can verify the verifier's identity and/or the verifier's membership in one or more channels on the blockchain network (102).

As a reward or incentive for verifying the EDI data, the verifier can receive an EDI token issued for the verifier. The EDI token can be sent to a blockchain wallet associated with the verifier. The blockchain wallet can be a wallet on a public blockchain (e.g., 104), such as Ethereum Mainnet, for example. Moreover, the EDI token can be issued for the verifier based on a token distribution smart contract (e.g., 110).

At step 412, the method can involve, based on the signed transaction, creating, by the orderer (e.g., 128), one or more transaction blocks including the EDI data. At step 414, the method can involve propagating, by the orderer (e.g., 128), the one or more transaction blocks onto the permissioned blockchain (e.g., 120) via one or more channels (e.g., 116) selected for the one or more transaction blocks. In some examples, the transaction blocks can be distributed via a channel selected based on the country or jurisdiction associated with the EDI data, the entities associated with the EDI data, channel membership details, the content of the EDI data, etc. Once the EDI data has been distributed, the entities (e.g., peers 118) in the blockchain network (102) can access the EDI data from their respective copies of the ledger (120) on their nodes.

The blockchain network (102) can have multiple channels (116) for accessing and/or distributing EDI data. The channels can provide isolation of EDI data based on the jurisdiction or government pertaining to the EDI data, the parties involved in an EDI transaction associated with the EDI data, the parties authorized to access the EDI data, the content of the data, channel memberships, etc. Each entity in the blockchain network (102) can have a common identity across all channels that the entity is a member of. This can ensure uniformity of identities across all channels, secure and consistent compartmentalization of EDI data, privacy, etc. Channel memberships can be established and authorized by channel MSPs (e.g., 114). The channel MSPs can establish and/or authorize memberships based on respective certificates issued by the certificate authority (112).

In some examples, at some point prior to propagating the one or more transaction blocks onto the permissioned blockchain, the method can also involve sending the EDI data to a government entity associated with the EDI data for verification of the EDI data. The government entity can receive the EDI data and validate its accuracy. Since the EDI data pertains to the government entity, the government should be able to validate the EDI data.

In some implementations, the method can also involve storing, on the permissioned blockchain, a respective smart contract (e.g., 126) defining respective obligations for an EDI transaction between a government entity and a private entity. The EDI transaction can be based on EDI data on the permissioned blockchain and/or EDI data submitted by a contributor (e.g., 106). The method can further involve receiving, by the verifier (e.g., 124) from a peer node (e.g., 118) associated with the private entity, an indication that the private entity has completed the obligations associated with the private entity, and based on the respective smart contract (e.g., 126), verifying that the private entity has fulfilled the obligations associated with the private entity. In some cases, the indication that the private entity has completed the obligations can be received from an oracle on the peer node (e.g., 118) associated with the private entity. The oracle can be, for example, a decentralized RegTech application on the peer node configured to function as an oracle.

Once the verifier (e.g., 124) verifies the obligations associated with the private entity, the respective smart contract (e.g., 126) can execute and one or more blocks with the compliance data can be hashed, stored on the permissioned blockchain and sent to the private entity and the government entity. The one or more blocks can include a record of the EDI transaction, an indication that the respective obligations have been fulfilled and the EDI transaction has been completed, and/or any data pertaining to the EDI transaction.

In other implementations, when the verifier (e.g., 124) verifies the obligations associated with the private entity, a notification can be sent to a peer node (e.g., 118) associated with the government entity indicating that the private entity has fulfilled its obligations for the EDI transaction. In response to receiving, from the peer node (e.g., 118) associated with the government entity, an acceptance of the verification of the respective obligations under the EDI transaction, the respective smart contract (e.g., 126) associated with the EDI transaction can execute to verify and store the EDI transaction with finality. In some cases, the acceptance of the verification can be received from an oracle on the peer node (e.g., 118) associated with the government entity. The oracle can be, for example, a decentralized GovTech application on the peer node configured to function as an oracle.

As a reward or incentive for verifying the EDI transaction, the verifier can receive an EDI token issued for the verifier. The EDI token can be sent to a blockchain wallet of the verifier. The blockchain wallet can be a wallet on a public blockchain (e.g., 104), such as Ethereum Mainnet, for example. Moreover, the EDI token can be issued for the verifier based on a token distribution smart contract (e.g., 110).

The disclosure now turns to FIG. 5, which illustrates an example computing device with example hardware components suitable for interacting with the ecosystem 100, running peer nodes, hosting decentralized applications or oracles, and performing any other computing operations.

In particular, FIG. 5 illustrates an example architecture of a system 500, including various hardware computing components which are in electrical communication with each other using a connection 506. System 500 includes a processing unit (CPU or processor) 504 and a system connection 506 that couples various system components including the system memory 520, such as read only memory (ROM) 518 and random access memory (RAM) 516, to the processor 504.

The system 500 can include a cache of high-speed memory connected directly with, in close proximity to, or integrated as part of the processor 504. The system 500 can copy data from the memory 520 and/or the storage device 508 to the cache 502 for quick access by the processor 504. In this way, the cache can provide a performance boost that avoids processor 504 delays while waiting for data. These and other modules can control or be configured to control the processor 504 to perform various actions. Other system memory 520 may be available for use as well. The memory 520 can include multiple different types of memory with different performance characteristics.

The processor 504 can include any general purpose processor and a service component, such as service 1 510, service 2 512, and service 3 514 stored in storage device 508, configured to control the processor 504 as well as a special-purpose processor where software instructions are incorporated into the actual processor design. The processor 504 may essentially be a completely self-contained computing system, containing multiple cores or processors, a bus, memory controller, cache, etc. A multi-core processor may be symmetric or asymmetric.

To enable user interaction with the computing device 500, an input device 522 can represent any number of input mechanisms, such as a microphone for speech, a touch-sensitive screen for gesture or graphical input, keyboard, mouse, motion input, speech and so forth. An output device 524 can also be one or more of a number of output mechanisms known to those of skill in the art. In some instances, multimodal systems can enable a user to provide multiple types of input to communicate with the computing device 500. The communications interface 526 can generally govern and manage the user input and system output. There is no restriction on operating on any particular hardware arrangement and therefore the basic features here may easily be substituted for improved hardware or firmware arrangements as they are developed.

Storage device 508 can be a non-volatile memory, a hard disk, or any other type of computer readable media which can store data for access by a computer, such as magnetic cassettes, flash memory cards, solid state memory devices, digital versatile disks, cartridges, random access memories (RAMs) 516, read only memory (ROM) 518, and hybrids thereof. In some cases, storage device 508 can store an execution or runtime environment for executing code, one or more functions for execution via the execution or runtime environment, one or more resources (e.g., libraries, data objects, APIs, etc.), and so forth.

The system 500 can include an integrated circuit 528, such as an application-specific integrated circuit (ASIC) configured to perform various operations. The integrated circuit 528 can be coupled with the connection 506 in order to communicate with other components in the system 500.

The storage device 508 can include software services 510, 512, 514 for controlling the processor 504. In some cases, the software services 510, 512, 514 can include, for example, operating system or kernel services, application services, services associated with one or more functions, etc. Other hardware or software modules are contemplated. The storage device 508 can be connected to the system connection 506. In one aspect, a hardware module that performs a particular function can include the software component stored in a computer-readable medium in connection with the necessary hardware components, such as the processor 504, connection 506, output device 524, and so forth, to carry out the function.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” a set indicates that one member of the set or multiple members of the set satisfy the claim. For example, claim language reciting “at least one of A and B” means A, B, or A and B.

What is claimed is:

1. A method comprising:
establishing, via a certificate authority on a blockchain network, respective identities of entities interacting with the blockchain network, the entities comprising one or more contributors, one or more verifiers, and a plurality of actors, each of the respective identities being associated with a respective certificate issued by the certificate authority;
receiving economic development incentive (EDI) data submitted by a contributor for storage on a permissioned blockchain of the blockchain network;
verifying, by a verifier on the blockchain network, the EDI data and a respective identity of the contributor based on an EDI smart contract associated with the permissioned blockchain of the blockchain network;
in response to verifying the EDI data and the respective identity of the contributor:
sending, by the verifier to an orderer on the blockchain network, a signed transaction comprising the EDI data; and
sending, to a blockchain wallet associated with the contributor, one or more EDI tokens issued for the contributor based on a token distribution smart contract, wherein the blockchain wallet is associated with a public blockchain;
based on the signed transaction, creating, by the orderer, one or more transaction blocks comprising the EDI data; and
propagating, by the orderer, the one or more transaction blocks onto the permissioned blockchain via one or more channels selected for the one or more transaction blocks.

2. The method of claim 1, wherein the plurality of actors comprise one or more private entities and one or more government entities, and wherein the EDI data comprises legislation data associated with a respective government entity from the one or more government entities.

3. The method of claim 2, further comprising:
prior to propagating the one or more transaction blocks onto the permissioned blockchain, sending the EDI data to the respective government entity for verification of the EDI data.

4. The method of claim 2, further comprising:
implementing, on the permissioned blockchain, a respective smart contract defining respective obligations for an EDI transaction between the respective government entity and a respective private entity from the one or more private entities, the EDI transaction being based on the EDI data;
receiving, by the verifier from a first peer node associated with the respective private entity, an indication that the respective private entity has completed one or more of the respective obligations associated with the respective private entity;
verifying, via the respective smart contract, that the respective private entity has fulfilled the one or more of the respective obligations associated with the respective private entity, to yield a verification of the one or more of the respective obligations;
storing, on the permissioned blockchain, at least one transaction block associated with the EDI transaction, the at least one transaction block comprising the verification of the one or more of the respective obligations; and
sending the at least one transaction block to the first peer node associated with the respective private entity and a second peer node associated with the respective government entity.

5. The method of claim 4, further comprising:
sending, to a second blockchain wallet associated with the verifier, an EDI token issued for the verifier based on a second token distribution smart contract, wherein the second blockchain wallet is associated with the public blockchain.

6. The method of claim 4, further comprising:
sending, to a second peer node associated with the respective government entity, the indication that the respective private entity has completed one or more of the respective obligations associated with the respective private entity; and
in response to receiving, from the second peer node, an acceptance of the verification of the one or more of the respective obligations, executing the respective smart contract associated with the EDI transaction;
wherein the indication that the respective private entity has completed one or more of the respective obligations is received from a first oracle on the first peer node, and wherein the acceptance of the verification is received from a second oracle on the second peer node, the first oracle comprising a decentralized RegTech application and the second oracle comprising a decentralized GovTech application.

7. The method of claim 1, wherein verifying the EDI data comprises at least one of validating an accuracy of the EDI data, checking that all mandatory fields for the EDI data are included, checking a format of the EDI data, and checking the EDI data for errors.

8. The method of claim 1, further comprising:
after receiving the EDI data submitted by the contributor, formatting the EDI data based on a formatting scheme defined for data submitted to the permissioned blockchain.

9. The method of claim 1, wherein the blockchain network comprises a plurality of channels for accessing and distributing respective EDI data, wherein memberships for the plurality of channels are determined based on the respective identities, each entity having a common identity across all channels the entity is a member of.

10. The method of claim 9, wherein establishing the respective identities of entities is based on respective public and private keys associated with the entities.

11. A system comprising:
one or more processors; and
at least one computer-readable storage medium having stored therein instructions which, when executed by the one or more processors, cause the system to:
establish respective identities of entities interacting with a blockchain network, the entities comprising one or more contributors, one or more verifiers, and a plurality of actors, each of the respective identities being established via a respective certificate issued for a respective entity;
receive economic development incentive (EDI) data submitted by a contributor for storage on a permissioned blockchain of the blockchain network;
verify, by a verifier on the blockchain network, the EDI data and a respective identity of the contributor based on an EDI smart contract associated with the permissioned blockchain of the blockchain network;
in response to verifying the EDI data and the respective identity of the contributor:
send, by the verifier to an orderer on the blockchain network, a signed transaction comprising the EDI data; and
send, to a blockchain wallet associated with the contributor, one or more EDI tokens issued for the contributor based on a token distribution smart contract, wherein the blockchain wallet is associated with a public blockchain;
based on the signed transaction, create, by the orderer, one or more transaction blocks comprising the EDI data; and
propagate, by the orderer, the one or more transaction blocks onto the permissioned blockchain via one or more channels selected for the one or more transaction blocks.

12. The system of claim 11, wherein the plurality of actors comprise one or more private entities and one or more government entities, and wherein the EDI data comprises legislation data associated with a respective government entity from the one or more government entities.

13. The system of claim 12, the at least one computer-readable storage medium storing instructions which, when executed by the one or more processors, cause the system to:
send the EDI data to the respective government entity for verification of the EDI data prior to propagating the one or more transaction blocks onto the permissioned blockchain.

14. The system of claim 12, the at least one computer-readable storage medium storing instructions which, when executed by the one or more processors, cause the system to:
implement, on the permissioned blockchain, a respective smart contract defining respective obligations for an EDI transaction between the respective government entity and a respective private entity from the one or more private entities, the EDI transaction being based on the EDI data;
receive, by the verifier from a first peer node associated with the respective private entity, an indication that the respective private entity has completed one or more of the respective obligations associated with the respective private entity;
based on the respective smart contract, verify that the respective private entity has fulfilled the one or more of the respective obligations associated with the respective private entity, to yield a verification of the one or more of the respective obligations;
record, on the permissioned blockchain, at least one transaction block associated with the EDI transaction, the at least one transaction block comprising the verification of the one or more of the respective obligations; and
send the at least one transaction block to the first peer node associated with the respective private entity and a second peer node associated with the respective government entity.

15. The system of claim 14, the at least one computer-readable storage medium storing instructions which, when executed by the one or more processors, cause the system to:
send, to a second blockchain wallet associated with the verifier, an EDI token issued for the verifier based on a second token distribution smart contract, wherein the second blockchain wallet is associated with the public blockchain.

16. The system of claim 11, wherein verifying the EDI data comprises at least one of validating an accuracy of the EDI data, checking that all mandatory fields for the EDI data are included, checking a format of the EDI data, and checking the EDI data for errors, wherein the blockchain network comprises a plurality of channels for accessing and distributing respective EDI data, and wherein memberships for the plurality of channels are determined based on the respective identities, each entity having a common identity across all channels the entity is a member of.

17. At least one non-transitory computer-readable storage medium having stored therein instructions which, when executed by one or more processors, cause the one or more processors to:
establish respective identities of entities interacting with a blockchain network, the entities comprising one or more contributors, one or more verifiers, and a plurality of actors, each of the respective identities being established via a respective certificate issued for a respective entity;
receive economic development incentive (EDI) data submitted by a contributor for storage on a permissioned blockchain of the blockchain network;
verify, by a verifier on the blockchain network, the EDI data and a respective identity of the contributor based on an EDI smart contract associated with the permissioned blockchain of the blockchain network;
in response to verifying the EDI data and the respective identity of the contributor:
send, by the verifier to an orderer on the blockchain network, a signed transaction comprising the EDI data; and
send, to a blockchain wallet associated with the contributor, one or more EDI tokens issued for the contributor based on a token distribution smart contract, wherein the blockchain wallet is associated with a public blockchain;
based on the signed transaction, create, by the orderer, one or more transaction blocks comprising the EDI data; and
propagate, by the orderer, the one or more transaction blocks onto the permissioned blockchain via one or more channels selected for the one or more transaction blocks.

18. The least one non-transitory computer-readable storage medium of claim 17, storing instructions which, when executed by the one or more processors, cause the one or more processors to:
after receiving the EDI data submitted by the contributor, format the EDI data based on a formatting scheme defined for data submitted to the permissioned blockchain.

19. The least one non-transitory computer-readable storage medium of claim 17, wherein the plurality of actors comprise one or more private entities and one or more government entities, and wherein the EDI data comprises legislation data associated with a respective government entity from the one or more government entities.

20. The least one non-transitory computer-readable storage medium of claim 19, storing instructions which, when executed by the one or more processors, cause the one or more processors to:
implement, on the permissioned blockchain, a respective smart contract defining respective obligations for an EDI transaction between the respective government entity and a respective private entity from the one or more private entities, the EDI transaction being based on the EDI data;
receive, by the verifier from a first peer node associated with the respective private entity, an indication that the respective private entity has completed one or more of the respective obligations associated with the respective private entity;
verify, via the respective smart contract, that the respective private entity has fulfilled the one or more of the respective obligations associated with the respective private entity, to yield a verification of the one or more of the respective obligations;
store, on the permissioned blockchain, at least one transaction block associated with the EDI transaction, the at least one transaction block comprising the verification of the one or more of the respective obligations; and
send, to a second blockchain wallet associated with the verifier, an EDI token issued for the verifier based on a second token distribution smart contract, wherein the second blockchain wallet is associated with the public blockchain.
